(19) United States
(12) Patent Application Publication
(10) Pub. No.: US 2017/0159900 A1
(43) Pub. Date: Jun. 8, 2017

(54) ELECTRONIC ARTIFICIAL FLAME DEVICE

(71) Applicant: The Gerson Company, Olathe, KS (US)

(72) Inventors: James Gerson, Kansas City, MO (US); John Hjalmarson, Leawood, KS (US); Lynda Musante, Olathe, KS (US); Orin Borgelt, Olathe, KS (US); Jeff Alholm, Leawood, KS (US); Ian McEwan, Pasadena, CA (US); James Crabb, Kansas City, MO (US); Jacob Davisson, Olathe, KS (US); Chris Aguayo, Glendale, CA (US)

(73) Assignee: The Gerson Company, Olathe, KS (US)

(21) Appl. No.: 15/012,665

(22) Filed: Feb. 1, 2016

Related U.S. Application Data
(60) Provisional application No. 62/263,474, filed on Dec. 4, 2015.

(51) Int. Cl. F21S 10/04; H05B 37/02; F21V 7/00; F21V 23/00; F21S 6/00; G02B 27/30; H05B 33/08; F21S 9/02

(52) U.S. Cl. CPC F21S 10/04; H05B 33/0854; H05B 37/0218; H05B 37/0272; H05B 33/0857; F21S 9/02; H05B 37/0227; F21V 23/005; F21S 6/001; G02B 27/30; F21V 7/00; F21Y 2115/10

(57) ABSTRACT

An electronic artificial flame device for providing an artificial flame having realistic flame colors and apparent flame motion, in multiple dimensions of chromaticity, luminosity, plasma anger, and spatial walk, coordinated by a mathematical model based on real flame. The device includes input electronics, output electronics, light assemblies, and a flame screen. The input electronics implement the model of a real flame, and the light assemblies, which include one or more light emitting diodes, emit light under control of the output electronics. The light assemblies direct the emitted light onto the flame screen, and the flame screen reflects the directed light to provide the visible aspect of the artificial flame. The mathematical model includes a flame model, a color conversion function, and a projection function for modeling, respectively, the shape, color, and movement of the real flame, and may also include an additional output noise function. Sensors may detect air movement or other ambient conditions such as light or movement, and influence the model.

### RELATED APPLICATIONS

The present U.S. non-provisional patent application is related to and claims priority benefit of an earlier-filed U.S. provisional patent application titled “Artificial Electronic Flame”, Ser. No. 62/263,474, filed Dec. 4, 2015. The entire content of the identified earlier-filed application is hereby incorporated by the reference into the present application.

### FIELD

The present invention relates to devices for electronically producing artificial flames, such as electric candles, tea lights, and lanterns.

### BACKGROUND

Existing electric candles that produce artificial flames generally do not produce sufficiently realistic flame colors, flicker, dynamic brightness, body glow, or sufficiently realistic apparent motion. Some electric candles employ a single light-emitting diode (LED) which provides only flickering light, and gives the appearance of a flame hidden within a diffuse shell, often without changing color and/or apparent motion. Other electric candles employ moving flame-shaped screens, but these are generally fragile and stop appearing realistic to observers after a short period of observation. Still other electric candles employ two LEDs projected so as to overlap each other to produce apparent motion. This approach cannot be extended to more than two LEDs because changes in the brightness of the LEDs are not correlated, so observers see noise and are not fooled into seeing motion. Further, electric candles employing this approach are limited to being viewed from a single direction (e.g., from directly in front of the projection), and viewing from any other direction around the candle results in seeing an even more obviously unrealistic flame.

All these approaches do not mimic the interdependent changes in color (also referred to as chromaticity), luminosity (also called brightness), spatial movement (also referred to as the walk or spatial walk), or the plasma noise (called anger, jitter, or plasma anger in this document) of a real flame.

This background discussion is intended to provide information related to the present invention which is not necessarily prior art.

### SUMMARY

Embodiments of the present invention solve the above-described and other problems and limitations by providing an electronic artificial flame device configured to provide a more realistic artificial flame, including more realistic flame colors and apparent flame motion, in multiple dimensions of chromaticity, luminosity, spatial walk, and plasma anger, coordinated by a mathematical model based on the attributes of real flame. The resulting artificial flame better mimics the colors and movements of a real flame, and may be viewed with good results from substantially any direction around the device. Further, because in some embodiments the artificial flame results largely from software rather than hardware, its characteristics can be more quickly and easily changed as desired.

In one embodiment of the present invention, an electronic device for providing an artificial flame may broadly comprise input electronics, output electronics, one or more light assemblies, and a flame screen. The input electronics may be configured to implement a mathematical model of a real flame, and the output electronics may be configured to drive one or more LEDs in the light assemblies in accordance with control signals generated by the input electronics. As used here, “light assembly” includes a combination of one or more LEDs and any technique used to manipulate the LED output to control where the output falls. In one example embodiment described herein collimators and other mechanical components are used to focus light upon the projection surface while allowing some energy to fall down within the body of the candle. The one or more light assemblies may be configured to direct the light from the one or more LEDs, and the flame screen may be configured to reflect the light directed by the one or more light assemblies.

Various implementations of this embodiment may include any one or more of the following additional features. The mathematical model may be a multi-dimensional dynamic model of the real flame. The mathematical model may include a flame model configured with a parameterize shape of the real flame, a color conversion function which may be a parameterized fit to the color of the real flame, and a projection function configured with parameterized flame movement. The shape of the real flame may be parameterized by a shape such as a cone, a cylinder, a volume of revolution of circle segments, a volume of revolution of parabolas, a volume of revolution of splines, or a Gaussian. The color of the real flame may be parameterized by a fit to color temperature. The movement of the real flame may be parameterized with a function such as a two-dimensional turbulence model, a random walk, or a correlated noise function. The mathematical model may further include an additional output noise function reflecting plasma anger. There may be an even number of LEDs, and the plasma anger noise function may add noise to each pair of LEDs, with each LED in a particular pair of LEDs being varied in brightness with respect to the other LED in the particular pair of LEDs. The device may further include a body configured to support the flame screen and having a shape and a color resembling an object for producing real flame. The body may resemble an object such as a candle, a tea light, or a lantern. The LEDs may be provided on a flex circuit and positioned at an angle. The LEDs may be serially addressable multi-color surface mounted components with integrated drivers. The light assemblies may include round, multi-slit collimators, or alternatively have lenses, pin hole openings, or other projection modalities. If collimators are employed, the collimators may have bottoms, and the bottoms may allow an amount of the emitted light to leak to achieve the desired glow within the body, also called “body glow.” The device may further include a base configured to orient the light assemblies at an angle. The flame screen may be constructed of stacked reflective elements that provide an edge onto which at least some of the light is projected.

The device may further include one or more sensors configured to detect air movement proximate to the flame screen, and the mathematical model may be further configured to control the output electronics to represent the detected air movement. Each of the sensors may include one or more thin wire air temperature sensors positioned above one or more of the LEDs so as to be partially heated by the LEDs. The air movement detected by one candle or flame could be communicated wirelessly to another artificial flame in the area as to make it appear that air movement is causing all flames to move in concert. Alternative embodiments can include light detectors or motion detectors that detect ambient light or motion proximate to the flame screen respectively, and the mathematical model may be further configured to control the output electronics in response to the detected inputs received from the light or motion detectors. Other sensor types are also possible and the sensors may be used in any combination.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is an isometric view of an electronic artificial flame device constructed in accordance with an embodiment of the present invention;

FIG. 2 is an exploded elevation view of the electronic artificial flame device of FIG. 1;

FIG. 3 is a block diagram of components of the electronic artificial flame device of FIG. 1;

FIG. 4 is an isometric view of collimator components of the electronic artificial flame device of FIG. 1;

FIG. 5 is an isometric view of a base component of the electronic artificial flame device of FIG. 1;

FIG. 6 is an elevation view of a flame screen component of the electronic artificial flame device of FIG. 1;

FIG. 7 is a perspective view of a sensor component of the electronic artificial flame device of FIG. 1; and

FIG. 8 is a flow diagram depicting an embodiment of a software program for implementing the flame model of the electronic artificial flame device of FIG. 1.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly characterized, the present invention provides an electronic artificial flame device configured to provide a more realistic artificial flame, including more realistic flame colors and apparent flame motion, in multiple dimensions of chromaticity, luminosity, plasma anger, and spatial walk, coordinated by a mathematical model based on the attributes of real flame. In one embodiment, the device may be implemented by using the model to drive multiple LEDs in logical locations that match the LEDs' physical projection onto a flame screen and other locations within the body. The resulting artificial flame better mimics the colors, brightness, flicker, plasma anger and movements of real flame, and may be viewed with good results from substantially any direction around the device. Further, the use of a software model in the preferred embodiment, rather than hardware, means the characteristics of the artificial flame can be quickly, easily and dynamically changed as desired.

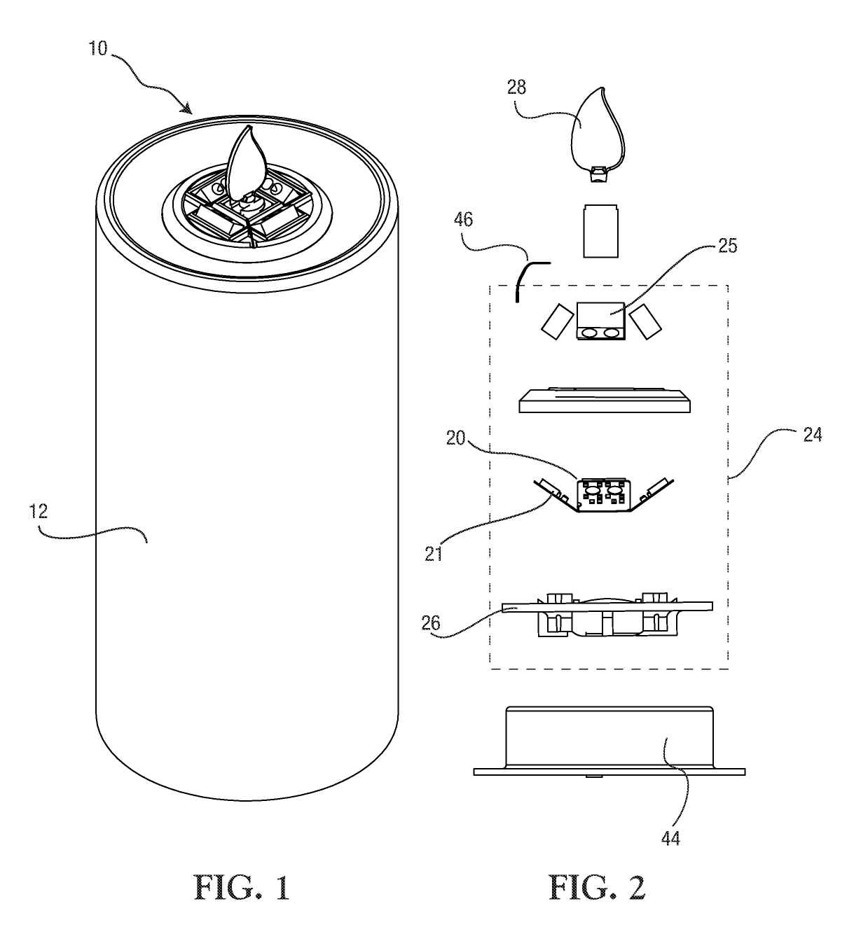

Referring to FIGS. 1, 2, and 3, an electronic artificial flame device 10 constructed in accordance with an embodiment of the present invention may broadly comprise a body 12, input electronics 14 configured to implement a mathematical model 16 of a real flame, output electronics 18 including drivers 22 for one or more LEDs 20, one or more light assemblies 24 configured to direct the outputs of the LEDs 20, a base 26, and a flame screen 28. The body 12 may take substantially any form, including the form of substantially any object associated with a real flame, such as a candle, tea light, lantern, or other flame-producing device. Further, the body 12 may be constructed of substantially any suitable material, especially material that is chosen, formed, or otherwise configured to more appropriately represent the object associated with the real flame. Thus, although described herein and shown in the figures for descriptive purposes as having the general form of a candle, the device 10 and its body 12 are not limited to this or any other particular form.

The input electronics 14 implement the mathematical model 16 of the real flame and involves various functions, including a flame model 32, a color conversion function 34, and a projection function 36. Implementation may be achieved using substantially any suitable technology, such as in software in a microcontroller or as digital logic in a field-programmable gate array (FPGA) or an application-specific integrated circuit (ASIC). The mathematical model 16 may be substantially any mathematical representation or parameterization of a flame. In one implementation, the mathematical model 16 may be a three-dimensional dynamic model that simulates fuel burning around a wick and producing hot particles that rise and glow, just as with a real flame, though this solution may be computationally intensive. In another implementation, the present invention may use one or more parameterizations of the flame shape, movement, and color of this full model, which greatly reduces the amount of processing power. The flame model 32 may parameterize the shape of the flame by a cone; a cylinder; a volume of revolution of circle segments, parabolas, or splines; or a Gaussian. A flame is generally well approximated by a solid, pinned at the wick, being blown around in oscillation. The color conversion function 34 may parameterize the color of the flame by using a color temperature conversion, because apart from the small blue glow at the bottom of the flame caused by light emitted from the actual combustion of the fuel, the color of a real flame is due to blackbody radiation from particulates in the visible flame being very hot. The projection function 36 may parameterize the movement of the flame by using a two-dimensional turbulence model, a random walk, or a correlated noise function, such as Perlin or simplex noise.

To increase perceived motion, the model 16 may also implement an additional output noise function 40. The noise function 40 may add noise to one or more pairs of LEDs 20. Each pair of LEDs 20 may be treated as a single projection in the walking flame model, with each LED in the pair being varied in brightness with respect to the other LED in the pair, driven by the noise generation function 40 so that the integrated whole remains a consistent brightness with the flame walk algorithm. The timing and amplitude of the noise may be referred to as the “anger” of the projection, and the anger of the projection may be tuned using software.

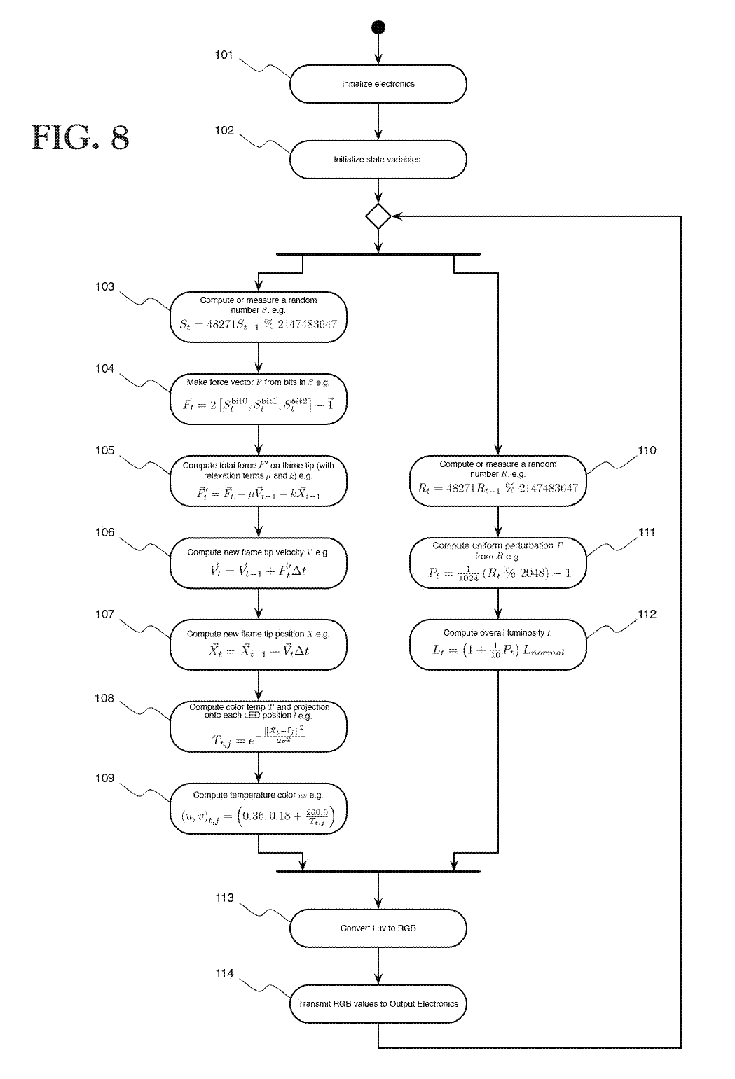

In more detail, FIG. 8 shows the flowchart for an example of a complete flame algorithm implemented in the digital electronics 14. This algorithm's flame motion model uses a randomly generated force to buffet the tip of a Gaussian shaped flame that is modeled as being attached at the flame base to a wick by a spring. The color conversion is done via a simple linear fit to the small part of the standard CIE 1960 Uniform Color Space (UCS) color temperature curve from 900 K to 2000 K which is the color range relevant for candles. When the device is first switched on, any electronic parts that need initializing are initialized 101, and all state variables, such as the flame position are initialized 102 before the main loop starts. The main loop has two threads and will repeat until the device is turned off. The first thread implements the flame motion model 32, color conversion 34 and projection 36 in the following steps: Compute a random number with the C++ 2011 standard linear congruential generator 103. The first 3 bits of the random number are used to make a random force vector 104. Compute the total force on the flame tip from the random force, a friction term and a spring like relaxation term 105. Compute the new velocity of the flame tip by integrating the force 106. Compute the new position of the flame tip by integrating the velocity 107. For this model the determination of the flame color is based on the physical location of the LED or LED pair as it operates with the moving color map which can be well approximated by a Gaussian function, also called a Gaussian or Gaussian shape. 108. The thread completes by converting the projected color temperature to a color in the CIE 1960 color space 109.

The second thread computes additional output (luminosity) noise 40 by computing a random number with the C++ 2011 standard linear congruential generator 110. The next step is to compute a uniformly random, −1 to +1, perturbation 111. This is followed by computing an overall luminosity including a 10% perturbation from the chosen normal luminosity 112. Finally the color and luminosity are combined and converted to a standard 24-bit RGB color space 113 and in 114 transmitted 42 to the output electronics 18. In this model the anger of the flame is enhanced by the right hand side of the figure that contains 110, 111, 112, also called the second thread. Each pair of LEDs is treated as a single projection and the pair being varied in brightness with respect to the other LED in the pair, driven by the noise generation function 110 and 111 so that the integrated whole remains a consistent brightness 112 with the flame walk algorithm. The timing and amplitude of the noise may be referred to as the plasma anger of the projection, and the anger of the projection may be tuned using software.

The output electronics 18 include the LED drivers 22, and are configured to drive the LEDs 20 to emit light under the control of the input electronics 14. The LEDs 20 and their drivers 22 may be separate or integrated components. In various implementations, communication 42 between the input electronics 14 and the output electronics 18 may be by way of discrete analog or digital signals for each LED, coded parallel digital signals for LEDs wired together in parallel, or coded serial digital signals for LEDs wired together in series.

The LEDs 20 may be a plurality (e.g., 8, or, more broadly, between 2 and 10) of surface-mounted LEDs configured as a projector array. In one embodiment only a single LED pair is used, limiting the field of view of the projected flame. The single pair model operates as if that pair still lived within a larger array of light assemblies. The LEDs 20 may be provided on a flex circuit 21 and appropriately angled to achieve the best results, wherein the angle may depend on the dimensions of the candle, flame tips, and light assemblies. As depicted in FIG. 2, the light assemblies include the base 26, LEDs 20, flex circuit 21, and collimators 25 that focus light emitted by the diodes on the flame screen 28. In this implementation collimators have been found to provide an appropriate focusing capability that performs well given the particular LEDs employed and the flame body glow provided by the flame screen. Other implementations are possible, including lenses to focus the light, LEDs with inherently more focused light output, or simply mounting the LEDs at different angles or in different proximity to the screen may provide equally effective results. The LEDs 20 may be serially addressable multi-color surface (RGB and White RGB) mounted LED components with integrated drivers 22, which allows the LEDs 20 to be controlled by a serial stream from a single pin of a processor. A white channel may be added to the traditional red, green, and blue (RGB). The white channel may provide a baseline white, and the RGB channels may be used to tune the white color or to add to the overall brightness. The LEDs 20 may be positioned between the light assembly collimators 25 and the base 26. Use of a flex circuit 21 allows for varying the angle of the bottom of the collimators 24 and the base 26. Individual circuit boards and wires could be used instead of a flex circuit.

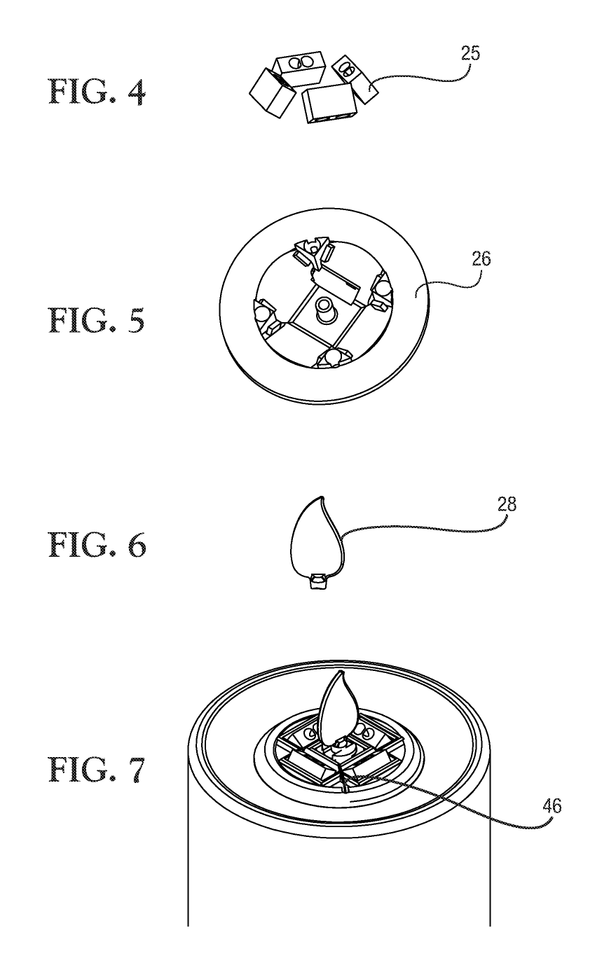

Referring also to FIG. 4, the collimators 25 may be configured to direct light from the LEDs 20 onto the flame screen 28. The collimators 25 may be two-slit collimators with that may or may not include angled septums to maximize or control the effect of color separation to the flame during the walk. Another embodiment modifies the plasma anger elements 110, 111, 112 such that the timing of the LED pairs in relationship to each other is tuned to create or enhance additional color separation. Further, the collimators 25 may be round to create the desired perceived focused motion. The bottoms of the collimators 25 may be tuned, by hardware, to allow an amount of light to leak into the body 12 in order to produce a “body glow.” The collimators 25 may be constructed of a plastic material using three-dimensional printing, cold molding, and/or injection molding. The plastic material may be reflective and dyed or otherwise colored to match the color of the housing (e.g., the “wax” of the candle-shaped housing). The plastic material may also be colorless to enhance the body glow of the candle or flame assembly.

Referring also to FIG. 5, the base 26 may receive and retain an end of the flame screen 28, and may receive and orient the collimators 24 and/or the LEDs 20 (e.g., the flex circuit on which the LEDs 20 are mounted) at an appropriate angle (e.g., 35 degrees).

Referring also to FIG. 6, the flame screen 28 may take the form of a flat or three-dimensional, static or moving screen, and may be cast, formed from flat stock or multiple pieces of flat stock, injection molded, or otherwise constructed of any material having the desired optical properties. The flame screen 28 may be constructed of material (e.g., polytetrafluoroethylene (PTFE)) having a reflective property that minimizes absorption of energy to improve perceived motion. In various implementations, the flame screen 28 may be constructed of stacked reflective elements that create a larger edge to project upon, and/or positioning elements orthogonal to each other.

As shown in FIG. 2, if the device 10 is battery powered, then it may include a battery housing 44 configured to house one or more batteries for powering the device's operation.

Referring also to FIG. 7, the device 10 may further include one or more sensors 46 configured to detect air movement. The detected air movement may be used by the flame model 16 and mimic the action of air on the flame. More specifically, real flames move and flicker differently in response to air movement. Prior art artificial flames do not respond to environmental changes, such as the movement of air around the flame. The present invention may use air temperature transducers or other sensors 46 to sense air movement around the device 10 and translate that movement into pseudo velocity and turbulence measurements suitable for input into the mathematical model 16 or one or more of its function components 32, 34, 36.

In one implementation, each sensor 46 may be a thin wire resistive or thermocouple air temperature sensor positioned above an LED 20 so that it is partially heated by the LED 20. The temperature measured by the sensor 46 may depend on the airflow around the wire, with more airflow producing a cooler wire. With several sensing wires, an airflow direction can be loosely determined. The resulting sensed values can be input to, e.g., the flame model 32 to imitate the effect of air movement on the flow. In particular, the sensor signal may be added to the walking model to mimic the change in flame behaviour resulting from a breath or other air movement. As described above, the model mimics motion by via a mathematical model that “walks” the flame to its spatial operating edges, also changing the color, luminosity, and plasma anger of the projection. When the sensor detects a drop in temperature, interpreted to be air motion, sensor output is injected into the model so that it moves the walk and other factors as if air is moving and changing the flame. Further, this feature may be configured to allow a plurality of devices 10 to behave in a wave like motion mimicking the passage of air across them.

Additional sensors can be optionally added or replace temperature sensor 46. For example, an optional motion detector, for example an inexpensive infrared implementation, can be incorporated. This might be used to cause some effect on the flame. Additionally, it may be used in conjunction with a time out feature, so that if there has been no motion near the body 12 for some significant period of time the flame projection is stopped to conserve battery power. An optional light sensor, for example a simple photovoltaic element, can also be used with the system. The light sensor can detect ambient light in a room, or near the body 12. Input from this sensor can be incorporated into the control algorithm, for example, to make the flame dimmer if the ambient light in the room is dimmer. This may be for power savings or for aesthetic reasons. Conversely, if the room is bright this may cause the control algorithm to make the flame brighter. Other uses for the light sensor will be apparent to those of skill in the art.

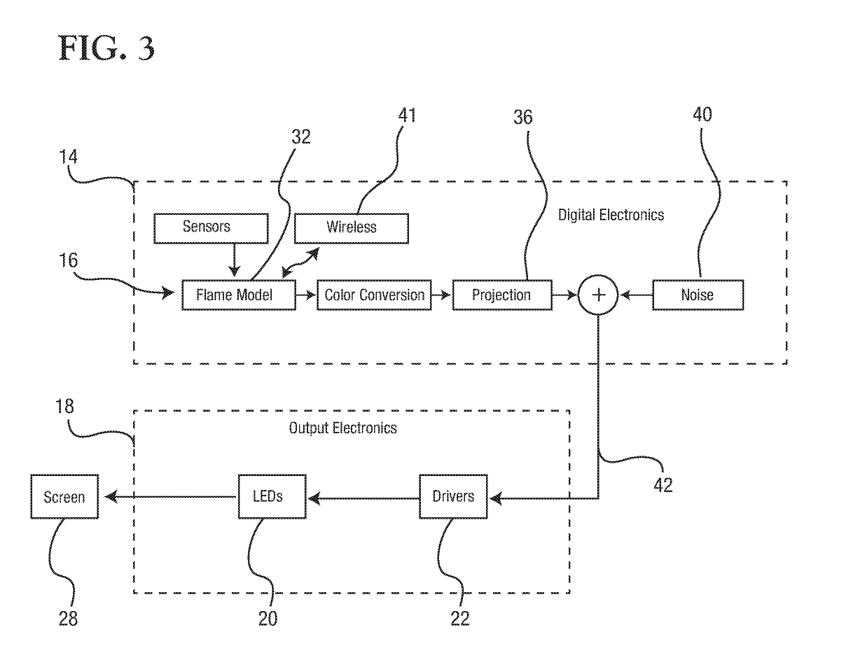

In one embodiment, the input electronics may contain transceiver circuitry capable of communicating in one or more of a plurality of radio bands and utilizing one or more of several communication protocols. Such circuitry is optionally depicted in FIG. 3 at 41 This well-known circuitry can include the capability to operate using Bluetooth, ANSI 802.11 (WiFi), Near Field Communication (NFC) and/or other wireless communication protocols as will be well understood by one of ordinary skill in the art. Bluetooth, 802.11 (WiFi), and NFC are industry standards for communication that are also supported in most new wireless phones. As is well known, smart phones with such wireless capability can be loaded with customized applications. With an application to configure to the flame product, all configurable aspects of the product could be modified and controlled or additional features sold, or provided for free, and downloaded to the product. While infrared (IR) based signals could be used for simple control, they generally lack the ability to communicate enough data for exchange and configuration; instead they are appropriate mostly for on-off and simple changes. Bluetooth, 802.11, and IR all require that the products battery is drained as it looks or listens for a command.

By providing the appropriate transceiver (or other and additional circuits) required for wireless communication, a plurality of devices 10 can be placed in proximity to each other and joined in a wireless network. Such a network may be provided by an external source, such as a local wireless LAN into which the devices 10 can join. Alternatively the devices 10 may be configured to create and join their own network. One device 10 could be configured as a wireless access point and project a network, with other devices 10 joining that network, or an adhoc network can be configured with no static coordinator. The circuitry and protocols for creating such a network are considered conventional and need not be further explained here. But the capabilities for inter-device communication provide additional possible functionality. For example, one device 10 may be the source of sensing environmental conditions as described above, and share that sensing with the other devices so that there is uniform reaction between the devices 10 and appropriate changes on the projection of each device are made in concert. In this way, for example, one device 10 may sense air movement and share that output with the other devices so that they all act as if responding to the same breeze. In one embodiment this would visually create the effect of a wave of air moving across a room as seen by the flames reacting differently in both space and time. Other functions that are enabled by having the devices 10 networked together will be apparent to those of skill in the art. The logic and control functions for handling all aspects of the wireless communication described above can be implemented in the same control circuitry that operates the flame model. It is also contemplated that the devices 10 may operate from another power source, such as wall power, which would aid in performing more power consuming functions as described herein overcoming any limitations imposed by battery power. For example, if one device 10 receives grid power it would become the coordinating access point for the other devices 10 while also being available to connect to either a local or wide area network connection to gain access to the internet. With access to the internet, the flames, body glow, or other added visual or sound cues can be programmed. For example, the devices 10 may be programmed to dim or turn on at sunrise and sunset, give a cue of the arrival of an email, text message, Facebook post alert, tweet, or other programmable triggers, share music to be played on an embedded speaker, or any number of additional functionalities that will be apparent to those of skill in the art. It is contemplated that in some embodiments these alerts can be implemented by a separate light assembly associated with a device 10 that can be used to provide visual alerts to the user.

NFC is a wireless technology that detects a transmitter without any use of its own power, using the energy of the radio waves themselves to power the device long enough to power up using its own battery. NFC has also become standard on almost all new smart phones, in this case allowing a user to power on the product by waving their phone or other NFC transmitter close by and then controlling the product via its NFC wireless link or turning on other wireless modalities.

NFC may be particularly useful and represent a significant cost savings when used as an in-store demonstration tool. Typically, in-store demonstration tools now require special packaging, including an extra battery, wires, and press button or other type of switch that allows users to test a product while on the shelf. Significant cost savings are possible if NFC is employed to operate and control the device 10. Because the NFC protocol allows for the circuitry to passively await a signal without relying on battery power, such circuitry will allow users to test the product while it is in its case and while using batteries only when demonstrated. The control logic in a demonstration mode can determine if the candle has been left alone for an appropriate period of time, indicating the consumer has moved on, and then turn off to conserve battery usage. This results in package and battery savings. While the wireless circuitry is shown as being integrated into the electronics, it is also possible to provide them as an external module that can be added after manufacture, so long as provision is made for later external connection. In one implementation, some or all of the input electronics 14 may be located remote from the LEDs 20, and may wirelessly receive sensor signals from the sensors 46 and transmit control signals to the device or product electronics 20. In such a configuration the device 10 would require no external buttons or switches further enhancing the aesthetic look of the device being mimicked with the flame projection feature.

In one implementation, the device 10 may be programmed or otherwise controlled from a remote location. Some or all elements of the flame parameters may be controllable, such as motion, brightness, power consumption, color, plasma anger, air sensing, sensitivity or reactivity to any sensor input, off timer, and frequency of motion. Such remote programming or control may be accomplished using an application on a smart phone. The smart phone application may additionally be configured to control multiple devices 10 at once. Pleasing patterns of illumination can be programmed by a user, for example a holiday or color theme. One or more candles could be controlled to mimic a breeze in a room, or be choreographed with music. The candles could also be configured to flash or visually indicate if the smart phone is receiving a communication such as texts, emails, voice calls, or any other alert from any other application as desired by the user. Additionally or alternatively, remote programming or other control may be accomplished via a website, either by the end-user, the producer or retailer, or a third-party. Further remote programming or other control may be accomplished hardwired or wirelessly, using, e.g., the wireless protocol and circuitry described above.

Although the invention has been described with reference to the one or more embodiments illustrated in the figures, it is to be understood that equivalents may be employed and substitutions made herein without departing from the scope of the invention as recited in the claims. For example, while a candle body has been shown and tea lights described, it is also contemplated that the invention can be employed to mimic a fire in a fireplace, or indeed be the basis of a flame projection in any setting where flame would be appropriate.

Having thus described one or more embodiments of the invention, what is claimed as new and desired to be protected by Letters Patent includes the following:

1. An electronic device for projecting an artificial flame, the electronic device comprising:
input electronics configured to implement a mathematical model of a real flame;
output electronics, configured to generate drive signals in response to the input electronics;
one or more light assemblies, including one or more light emitting diodes, configured to emit light in response to the drive signals and direct the light from the one or more light emitting diodes; and
a flame screen configured to reflect the light directed by the one or more light assemblies.

2. The electronic device as set forth in claim 1, wherein the mathematical model is a multi-dimensional dynamic model of the real flame.

3. The electronic device as set forth in claim 1, wherein the mathematical model includes—
a flame model configured with a parameterized shape of the real flame and a parameterized movement model; and
a color conversion function configured with a parameterized temperature color.

4. The electronic device as set forth in claim 3, wherein the shape of the real flame is parameterized by a shape selected from the group consisting of: cones, cylinders, volumes of revolution of circle segments, volumes of revolution of parabolas, volumes of revolution of splines, and Gaussians.

5. The electronic device as set forth in claim 3, wherein the parameterized movement model comprises generating a force to buffet elements of the body of the parameterized shape of the real flame, wherein the force may be influenced by an external sensor input.

6. The electronic device as set forth in claim 3, wherein the movement of the real flame is parameterized by a function selected from the group consisting of: two-dimensional turbulence models, random walks, and correlated noise functions.

7. The electronic device as set forth in claim 1, wherein the mathematical model includes an additional output noise function.

8. The electronic device as set forth in claim 7, wherein the one or more light emitting diodes are coupled in one or more pairs, and the noise function adds noise to each pair of light emitting diodes, with each light emitting diode in a particular pair of light emitting diodes being varied in brightness with respect to the other light emitting diode in the particular pair of light emitting diodes.

9. The electronic device as set forth in claim 1, further including a body configured to support the flame screen, the body having a shape and a color resembling an object for producing real flame.

10. The electronic device as set forth in claim 9, wherein the body resembles an object selected from the group consisting of: candles, tea lights, and lanterns.

11. The electronic device as set forth in claim 1, wherein the one or more light emitting diodes are provided on a flex circuit and positioned at an angle.

12. The electronic device as set forth in claim 1, wherein the one or more light emitting diodes are serially addressable multi-color surface mounted components with integrated drivers.

13. The electronic device as set forth in claim 1, wherein the one or more light assemblies comprise light directing structure selected from the group comprised of lens assemblies, through-hole LEDs and collimators.

14. The electronic device as set forth in claim 9, wherein the one or more light assemblies comprise one or more collimators that have bottoms, and the bottoms allow an amount of emitted light to leak into the body.

15. The electronic device as set forth in claim 1, further including a base configured to orient the one or more light assemblies at an angle.

16. The electronic device as set forth in claim 1, wherein the flame screen is constructed of reflective elements that provide an edge onto which at least some of the light is projected.

17. The electronic device as set forth in claim 1, further including one or more sensors configured to detect one of air movement proximate to the flame screen, motion proximate to the flame screen, or ambient light proximate to the flame screen and the mathematical model is further configured to control the output electronics to respond to the detected input.

18. The electronic device as set forth in claim 17, wherein at least one of the one or more sensors includes a thin wire air temperature sensor positioned above one of the light emitting diodes so as to be partially heated by the light emitting diode.

19. An electronic device for providing an artificial flame, the electronic device comprising:
input electronics configured to implement a mathematical model of a real flame, wherein the mathematical model includes—
a flame model configured with a parameterized shape of the real flame and parameterized movement,
a color conversion function configured as a fit to color temperature,
a projection function, and
an additional output noise function;
output electronics configured to generate output drive signals in response to the input electronics,
one or more light emitting diodes configured to emit light under control of the output electronics, wherein the one or more light emitting diodes are provided on a flex circuit and positioned at an angle;
one or more collimators configured to direct the light from the one or more light emitting diodes;
a flame screen configured to reflect the light directed by the one or more collimators; and
a body configured to support the flame screen and having a shape and a color resembling an object for producing real flame.

20. An electronic device for providing an artificial flame, the electronic device comprising:
input electronics configured to implement a mathematical model of a real flame, wherein the mathematical model includes—
a flame model configured with a parameterized shape of the real flame and parameterized movement,
a color conversion function configured as a fit to color temperature,
a projection function, and
an additional output noise function;
output electronics configured to generate output drive signals in response to the input electronics,
one or more light emitting diodes, configured to emit light under control of the output electronics, wherein the one or more light emitting diodes are provided on a flex circuit and positioned at an angle;
one or more collimators configured to direct the light from the one or more light emitting diodes;
a flame screen configured to reflect the light directed by the one or more collimators;
one or more air temperature sensors configured to detect air movement proximate to the flame screen, wherein the mathematical model is further configured to control the output electronics to represent the detected air movement; and
a body configured to support the flame screen and having a shape and a color resembling an object for producing real flame.
